(19) United States
(12) Patent Application Publication
(10) Pub. No.: US 2008/0130910 A1
(43) Pub. Date: Jun. 5, 2008

(54) GESTURAL USER INTERFACE DEVICES AND METHODS FOR AN ACCESSORY TO A WIRELESS COMMUNICATION DEVICE

(75) Inventors: JEREMY T. JOBLING, DEERFIELD, IL (US); JEREMY S. SLOCUM, ANTIOCH, IL (US); HAROLD L. WIKEL, MUSKEGO, WI (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE (IL)

(21) Appl. No.: 11/565,049

(22) Filed: Nov. 30, 2006

(51) Int. Cl. H04R 1/10; G06F 3/041

(52) U.S. Cl. 381/74; 178/18.03; 345/173

(57) ABSTRACT

Disclosed is a user interface of a headset that is situated on one or both sides of the headset. The disclosed user interface on two sides of the headset includes two touch-sensitive surfaces that are configured to detect certain gestural motions. The surfaces can detect sliding motions as well as pressure points. Grouping of gestures and movements may provide memory cues for users to remember which side of the headset to use for certain functions. In one embodiment, a first user interface that is situated on one side of the headset can provide communication controls. A second user interface that is situated on the other side of the headset can provide audio controls. In another embodiment, a user interface including a touch-sensitive surface is configured to detect up to six user inputs. Accordingly, two touch-sensitive surfaces may achieve the same amount of control as six buttons.

### FIELD

Disclosed are user interface devices and methods of a communication device, and more particularly gestural user interface devices and methods of a mobile communication device.

### BACKGROUND

The makers of wireless communication devices, including those of cellular telephones, are increasingly adding functionality to their devices. For example, cellular telephones include features such as music players, FM radios including stereo audio capabilities, still and video cameras, video streaming and two-way video calling, email functionality, Internet browsers, and organizers. The memory capacity of a wireless communication device may be equivalent to, for example, an MP3 player. Therefore a wireless communication device may operate as an audio entertainment device in addition to providing communication functions.

For mobile communication devices such as cellular telephones, a headset can provide handsfree operation and privacy that are important for both convenience and safety. A headset in communication with a mobile communication device and in particular one with a microphone provides a lightweight, wired or wireless two-way communication system. Due to their limited size and surface area, there are only a few locations on the headset that make placement of controls optimal and ergonomic. Accordingly, headsets may be limited by the functions they support while using a handsfree mode.

Headset buttons are more appropriately positioned on the ear bud of a headset as opposed to the band which may be on the back of the user's head. Manufacturers often include more than one button on each side of the headset. To add control functionality to the user interface of a headset without increasing the number of buttons, manufactures are multiplexing many functions onto one button. Accordingly, a user must remember and accurately press a button for various lengths of time to achieve various tasks. Poor user experience with many errors and failed tasks may result from multiplexing several functions onto one button.

### BRIEF DESCRIPTION OF THE DRAWINGS

FIG. 1 depicts a headset according to an embodiment;

FIG. 2 depicts a user interface that is a touch-sensitive surface according to an embodiment;

FIG. 3 illustrates that the user interface can be configured to detect linear movement along the touch-sensitive surface in a second direction according to an embodiment;

FIG. 4 illustrates that the touch-sensitive surface can be configured to detect pressure in one or more positions on the touch-sensitive surface to generate user input signals according to an embodiment;

FIG. 5 depicts a user interface that is a touch-sensitive surface according to an embodiment;

FIG. 6 illustrates that the user interface according to an embodiment can be configured to detect linear movement along the surface in a second direction;

FIG. 7 illustrates that the user interface according to an embodiment can receive user input such as a press on an area to provide a user input signal to a controller;

FIG. 8 illustrates that additional user gestural motions may be added according to an embodiment;

FIG. 9 depicts a cut away cross sectional view of a touch-sensitive surface in a housing according to an embodiment;

FIG. 10 depicts a headset assembly according to an embodiment, broken out into various components;

FIG. 11 depicts a headset assembly according to an embodiment including the earbud, and a touch-sensitive surface broken out;

FIG. 12A depicts a headset assembly according to an embodiment including a touch-sensitive surface mounted in the housing and an earbud;

FIG. 12B illustrates a side view including a contoured touch-sensitive surface that can be mounted in a housing and the earbud, and including depictions of a plurality of sensors that may be in different sensor regions;

FIG. 12C illustrates a side view including contoured touch-sensitive surface that is a variation from that of FIG. 12B that can be mounted in a housing and the earbud, and including depictions of a plurality of sensors that may be in different sensor regions;

FIG. 13 depicts a headset and includes arrows proximal earbuds on different sides of the headset according to an embodiment;

FIG. 14 depicts a headset according to an embodiment and includes an arrow indicating a pressure point for calling controls; and

FIG. 15 is a flowchart indicating a scenario including a series of input user signals that a user may provide to a touch-sensitive surface to generate output signals while the headset of FIG. 1 is in communication with a mobile communication device.

### DETAILED DESCRIPTION

It would be beneficial for a user interface of a headset to provide multiple functions in a small space but with minimal buttons. Disclosed is a user interface of a headset that is situated on one or both sides of the headset. In one embodiment, the disclosed user interface on two sides of the headset includes two touch-sensitive surfaces that are configured to detect certain gestural motions. In addition to the conventional “press” functionality of the control, the touch-sensitive control may also accommodate a directional slide. For example, the touch-sensitive surface is configured to detect linear movement along the surface in two directions to generate user input signals and is also configured to detect pressure on the touch-sensitive surface to generate user input signals. Accordingly, the surface can detect sliding motions as well as pressure points. Therefore, the user can press and slide in two directions along a touch-sensitive surface to allow three functions in the same space. Grouping of gestures may provide memory cues for users to remember which side of the headset to use for certain functions.

In one embodiment, a first user interface that is situated on one side of the headset can provide communication controls. The first user interface detects linear movement along the surface for communication controls such as volume control output signals. The first user interface for communication is also configured to detect pressure for both answer control output signals and communication end control output signals. A second user interface that is situated on the other side of the headset can provide audio entertainment controls. The second user interface detects linear movement along the surface for audio entertainment controls such as track control output signals. The second user interface for audio entertainment is also configured to detect pressure for both play control output signals and pause control output signals. Accordingly, three buttons may be mapped into the space of one button.

In another embodiment, a user interface including a touch-sensitive surface is configured to detect up to six user inputs. Accordingly, one touch-sensitive surface may achieve the same amount of control as six buttons. The touch-sensitive surface can detect linear movement along the surface in a first direction and additionally can detect a combination of linear movement along the surface in the first direction and of pressure held for a predetermined period of time. The touch-sensitive surface can detect linear movement along the surface in a second direction and additionally can detect a combination of linear movement along the surface in the second direction and of pressure held for a predetermined period of time. The touch sensitive surface can also detect brief pressure on the surface and to generate user input signals and can detect pressure that is held for a predetermined period of time.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

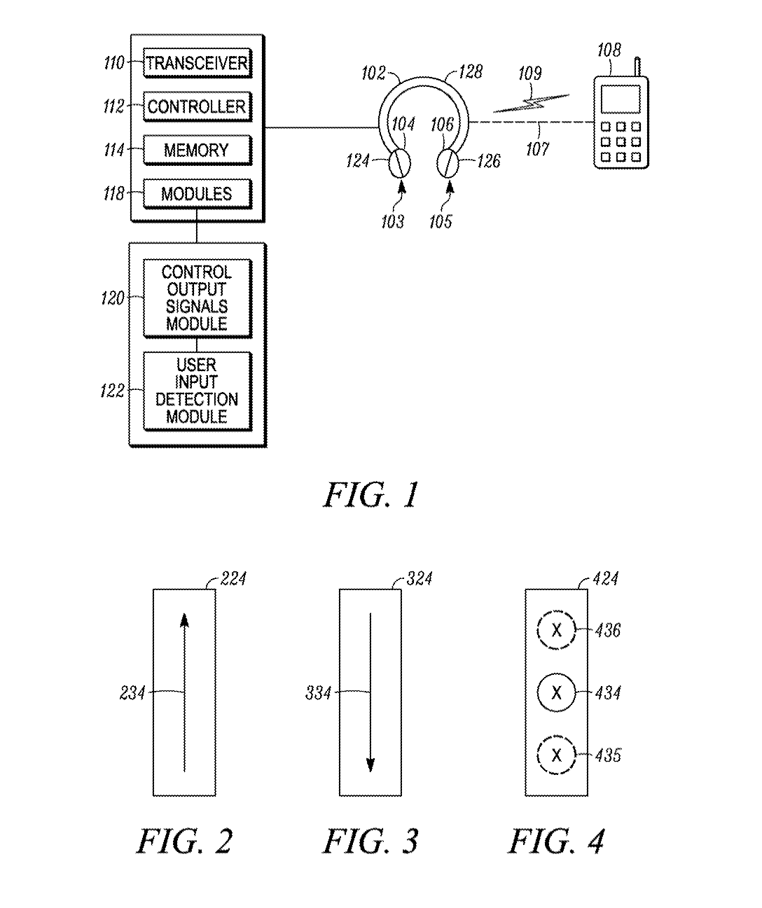

FIG. 1 depicts a headset according to an embodiment. Typically a headset 102 includes two earbuds, one for each of a user's ears. On a first side 103, a first earbud 104 is shown. On a second side 105, a second earbud 106 is shown. However, a headset may have only one earbud as well. Wired communication is indicated by the dotted line 107 to a mobile communication device 108. A wireless headset may be in communication with another device such as the mobile communication device 108. Wireless communication is indicated by a communication arrow 109.

The mobile communication device 108 may be implemented as a cellular telephone (also called a mobile phone). The mobile communication device 108 represents a wide variety of devices that have been developed for use within various networks. Such handheld communication devices include, for example, cellular telephones, MP3 players, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). While FIG. 1 depicts headset 102 in communication with a mobile communication device 108, it is understood that the headset 102 may be configured for wired or wireless communication with, for example, a typically non-mobile device such as a personal computer as well.

The headset 102 may be in communication with the mobile communication device 108 via a transceiver 110. User input signals may be received by a controller 112 that is configured to receive user input signals and generate control output signals to the mobile communication device 108 via the transceiver 110. Memory 114 may store instructions and other data. The instructions for the controller 112 may be considered as modules 118. For example, modules 118 may provide instructions to the controller to generate control output signals based on received detected user input signals according to control output signals module 120 and user input detection module 122.

The headset may include a first user interface 124 and a second user interface 126. A first user interface 124 may be located on the first side 103, the first user interface including a first touch-sensitive surface and coupled to the controller 112. While the first user interface 124 is shown as proximal the earbud 104, it may be positioned in another location, for example, on the headband 128 itself. Proximal the earbud 104 or on the band of the headset, a user may access the touch-sensitive surface easily and ergonomically. Grouping the controls by functionality and locating them on opposite sides of the headset may improve usability. For example, telephony controls may be grouped on the right side 103 of the headset 102 using the right hand gestures while music controls may be grouped on the left side 105 of the headset 102 using left hand gestures.

A second user interface 126 may be located on the second side 105, the second user interface including a second touch-sensitive surface and coupled to the controller 112. While the second user interface 126 is shown as proximal the earbud 106 it may be positioned in another suitable location, for example, on the headband 128 itself, as well. Other locations for the first 124 or second user interface 126 are contemplated by this discussion.

FIG. 2 depicts a user interface that is a touch-sensitive surface 224 according to an embodiment. FIGS. 2, 3 and 4 depict the same touch-sensitive surface 224, 324 and 424. The arrows and crossed areas illustrate some gestural motions that can provide the user interface user input to the controller 112 (see FIG. 1) that is configured to receive user input signals and generate control output signals. While the surface is depicted as a strip in the vertical direction, it is understood that the surface can be any shape and can have any orientation. The touch-sensitive surface 224 can be resistive, capacitive or any other type of touch-sensitive surface. A first user interface 124 may be on a first side 103 of the headset opposite the earbud 104. A second user interface 126, the same or similar to the first user interface 124, may be on the second side 105 of the headset opposite the earbud 106.

FIG. 2 illustrates that the user interface 224 can be configured to detect linear movement along the surface in a first direction 234. FIG. 3 illustrates that the user interface 324 can be configured to detect linear movement along the surface in a second direction 334. FIG. 4 illustrates that the touch-sensitive surface 424 can be configured to detect pressure in one or more positions on the touch-sensitive surface to generate user input signals. A user may tap or press the touch sensitive strip at any position. Pressure point 434 is depicted with a solid lined circle. Pressure points 435 and 436 are depicted with dashed circle lines to indicate that pressure as user input may be received in any point on the touch-sensitive surface to provide user input signals to the controller 112 (see FIG. 1).

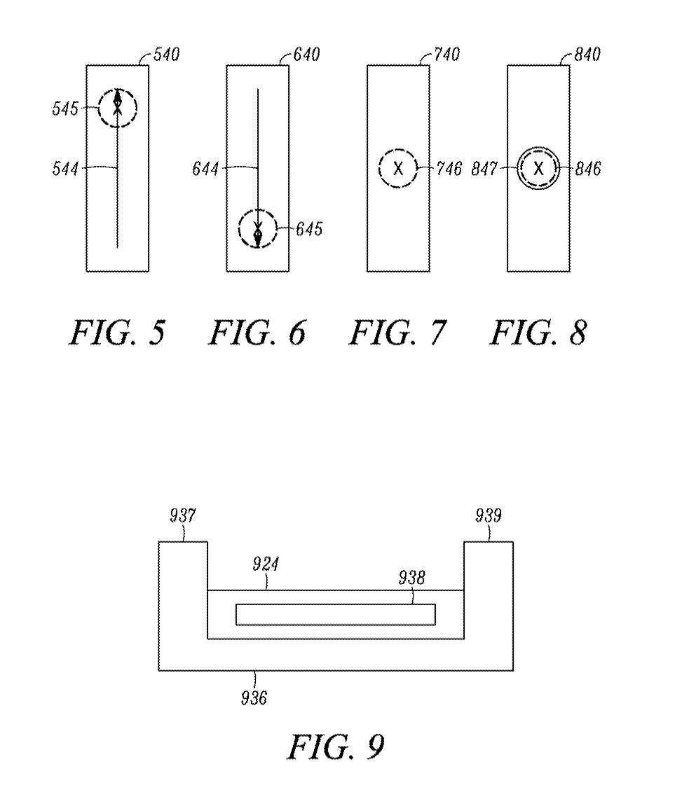

FIG. 5 depicts a user interface that is a touch-sensitive surface 540. FIGS. 5, 6, 7 and 8 depict the same touch-sensitive surface 540, 640, 740 and 840. The arrows and crossed areas illustrate the gestural motions that can provide the user interface up to six user inputs to the controller 112 (see FIG. 1) that is configured to receive user input signals and generate control output signals. More user inputs may be possible as well. As discussed above, while the surface is depicted as a strip in the vertical direction, it is understood that the surface can be any shape and have any orientation. The touch-sensitive surface 540 can be resistive, capacitive or any other type of touch-sensitive surface.

FIG. 5 illustrates that the user interface 540 can be configured to detect linear movement along the surface in a first direction 544 to provide user input signals to the controller 112. FIG. 5 further illustrates that the user interface 540 can be configured to detect a combination of linear movement along the surface in a first direction 544 and pressure held for a predetermined period of time to generate a user input signal shown as a dashed circle 545. The predetermined period of time can be for example one second.

FIG. 6 illustrates that the user interface 640 can be configured to detect linear movement along the surface in a second direction 644 to provide user input signals to the controller 112. FIG. 6 further illustrates that the user interface 640 can be configured to detect a combination of linear movement along the surface in a first direction 644 and pressure held for a predetermined period of time to generate a user input signal shown as a dashed circle 645. The predetermined period of time can be, for example, one second.

FIG. 7 illustrates that the user interface 740 can receive user input such as a press or tap on the area 746 to provide a user input signal to the controller 112. As discussed with reference to FIG. 4, the pressure may be detected at any position on the surface. If a popple is provided below the surface, a user may be inclined to press the surface at the popple. FIG. 8 illustrates that the user interface 840 can receive user input such as a press on area 846 and pressure held 847 for a predetermined period of time to generate a user input signal. The controller 112 (see FIG. 1) can receive the user input signals from up to six different user gestural motions. FIG. 8 further illustrates that additional user gestural motions may be added based on, for example, providing that pressure can be held 847 for two distinct predetermined periods of time. For example, one second may indicate a particular input signal and three seconds may indicate another input signal.

FIG. 9 depicts a cut away cross sectional view of, for example, a touch-sensitive surface 924 in a housing 936. One or more popples 938 can be provided under or on top of the surface 924 to give the user a distinct feeling of location of the pressure and holding positions. Haptic feedback may ensure a user understands that he or she is performing the correct gestures and functions. Alternatively or additionally, ridges 937 and 939 may be incorporated along the edges of the touch-sensitive surface to help guide the user's finger. The surface 924 of the user interface can be slightly inset from its housing 936 which can create a natural guidance of a user's finger along the surface or to a pressure location.

In another embodiment, auditory feedback may ensure that a user understands that he or she is performing the correct gestures and functions. For example, a tone or other auditory signal may be transmitted through the earbuds 104 and 106 (see FIG. 1) of the headset 102 when a particular function is commanded. Different tones or other auditory signals may be used for different functions. The user may be able to set a user preference to turn off or on the auditory feedback.

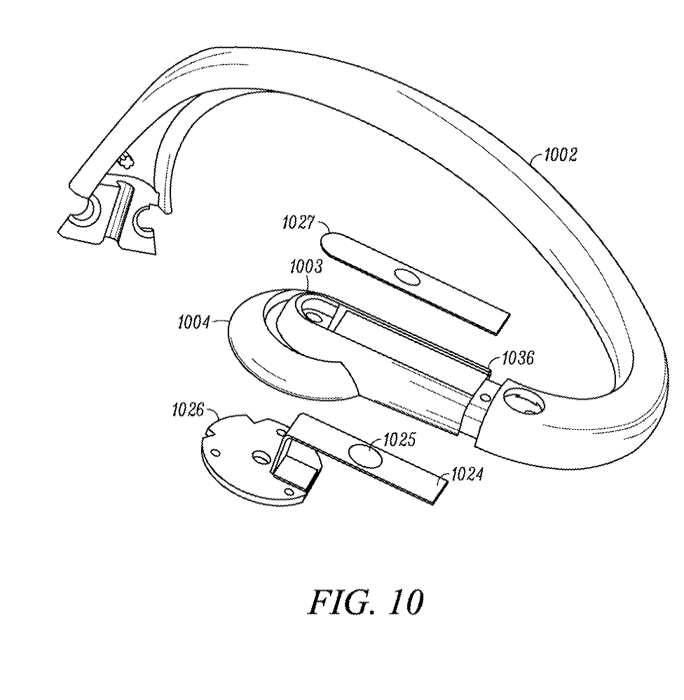

FIG. 10 depicts a headset 1002 assembly broken out into various components. In particular, a first side 1003 of the assembly is depicted. The touch-sensitive surface 1024 is depicted having an elongated shape. The surface 1024 may include a raised portion or dome 1025 to support placement and functioning of a popple. As mentioned above, the touch-sensitive surface can have any shape. The touch sensitive surface may be affixed by a conductive glue to a substrate 1026, for example, a PCB substrate for installation within or behind the earbud mounting 1004. The housing 1036 is shown to provide an inset for the touch-sensitive surface 1024. A cover layer 1027 may be applied over the strip 1024. The earbud mounting 1004 is also shown.

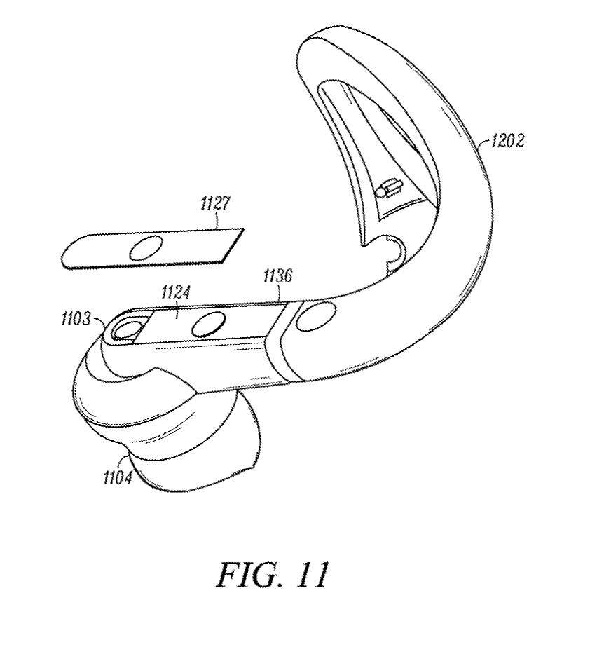

FIG. 11 depicts a headset 1102 assembly including a mounted earbud 1104, and the touch-sensitive surface 1124 broken out, along with the cover layer 1127 applied over the strip. In particular a first side 1103 of the assembly is depicted. The touch-sensitive surface 1124 is depicted having an elongated shape. The housing 1136 is shown to provide an inset for the touch-sensitive surface 1024.

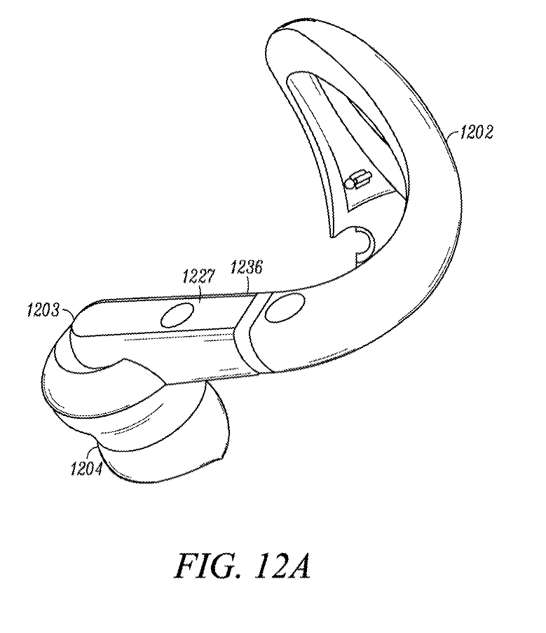

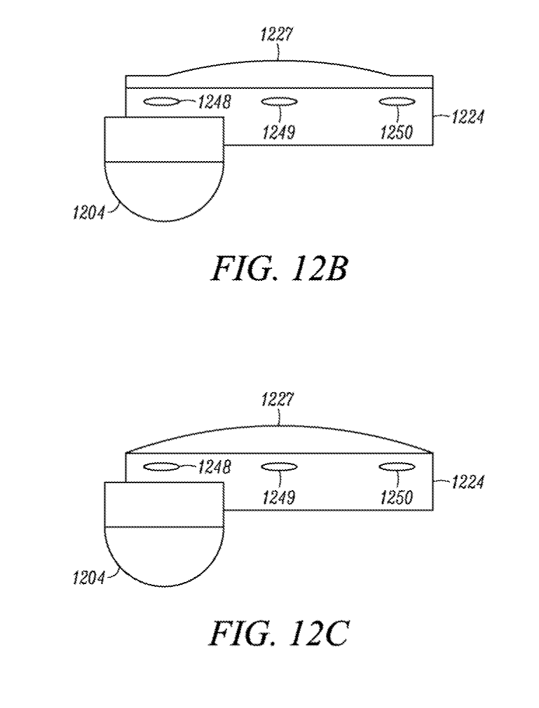

FIG. 12A depicts a headset 1202 assembly including the touch-sensitive surface 1224 (see FIG. 12B and 12C) mounted in the housing 1236 and the earbud 1204 mounted. In particular a first side 1203 of the assembly is depicted. The touch-sensitive surface is covered by a cover layer 1227, both depicted as having elongated shapes. The housing 1236 is shown to provide an inset for the touch-sensitive surface 1224 and its cover layer 1227. In this manner, the touch-sensitive surface of the user interface can be slightly inset from its housing 1236 which can create a natural guidance of a user's finger along the touch sensitive surface 1224 or to a pressure location.

As mentioned previously, in another embodiment illustrated in FIG. 9, ridges 937 and 939 may be formed along the surface 1227 edges to provide guidance to a user's finger. Regardless of the shape or tactile element applied, the three sensor regions 434, 435 and 436 (see FIG. 4) of the touch sensitive surface 1224 may have approximately a 7.5 mm edge to edge spacing. The edge to edge spacing of the two slide regions 435 and 436 may be approximately a distance of 15 mm. The touch sensitive element 1224 and its surface 1227 may have an inset in the housing as illustrated in FIG. 9 where the ridges 937 and 939 are raised for example approximately 0.3 mm and 0.5 mm. Different embodiments may provide ridges similar to ridges 937 and 939. For example, ridges may be on the surface 1227 of the touch sensitive surface 1224. To accommodate a majority of finger sizes, the ridges on either edge may be approximately 7 mm spaced apart. For tactile feel, the height of the ridges may be approximately 0.3 mm to 0.5 mm while not interfering with performance. On the other hand, or in addition, a single ridge may down the middle of a tactile touch area. For tactile feel, the height of the single ridge may be approximately 0.3 mm to 0.5 mm while not interfering with performance.

FIGS. 12B and 12C illustrate side views including the touch-sensitive surface 1224 that can be mounted in the housing 1236 (see FIG. 12A) and the earbud 1204, and including depictions of sensors 1248, 1249 and 1250 that may occupy different sensor regions such as sensor regions 434, 435 and 436 (see FIG. 4). The cover layer 1227 shown in FIG. 12B is a contour layer that may be used instead of or in addition to the above-described ridges. The cover layer surface 1227 above the middle sensor 1249 can be raised while keeping the surface 1227 above the upper sensor 1250 and the lower sensor 1248 that can be substantially flat. The raised surface 1227 above middle sensor 1249 may have a height, for example, of equal to or less than approximately 3 mm above the upper and lower portions of the surface 1227 to provide a smooth sliding interaction. The upper and lower surface 1227 may have the same height. The surface 1227 shown in FIG. 12C can have a continuous curve with the peak of the curve above the middle sensor 1249. The upper and lower portions of the surface 1227 may have the same height. While the touch sensitive layer 1224 and the surface 1227 are depicted as separate layers, they may be incorporated into a single layer.

With reference to FIGS. 2-12, various embodiments of a described touch-sensitive surface have been illustrated. Three or more user inputs can be detected by a touch-sensitive surface according to gestural motions. Accordingly, the described user interfaces of a headset may provide multiple functions in a small space but with minimal buttons.

In one embodiment, a wired or wireless, and particularly a Bluetooth headset includes a touch-sensitive surface on each side of the headset. Functions may be grouped to provide memory clues so a user can remember which side of the headset to use for certain functions. In one embodiment, three input motions can be received by each touch sensitive surface. While a user is wearing the headset, he or she can slide a finger along the one surface on for example, the right hand side to change or navigate music tracks. Pressing any part of that surface can alternate between play and pause controls. For the touch-sensitive surface on the other side, for example the left hand side of the headset, the user may slide a finger for volume control or adjustment. Pressing any part of that surface may allow the user to answer a call if there is an incoming call, or end a call if the user is currently engaged in communication. Accordingly, through resistive, capacitive or other touch sensitive technology, gestures may be used to map multiple functions onto a single control that can still be easily remembered and understood by the user. Positioning and grouping the controls as described above may make it easier for the user to provide user input via the user interface.

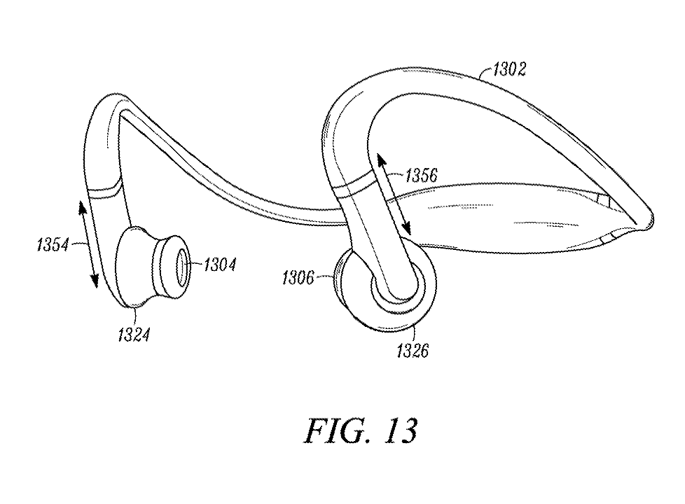

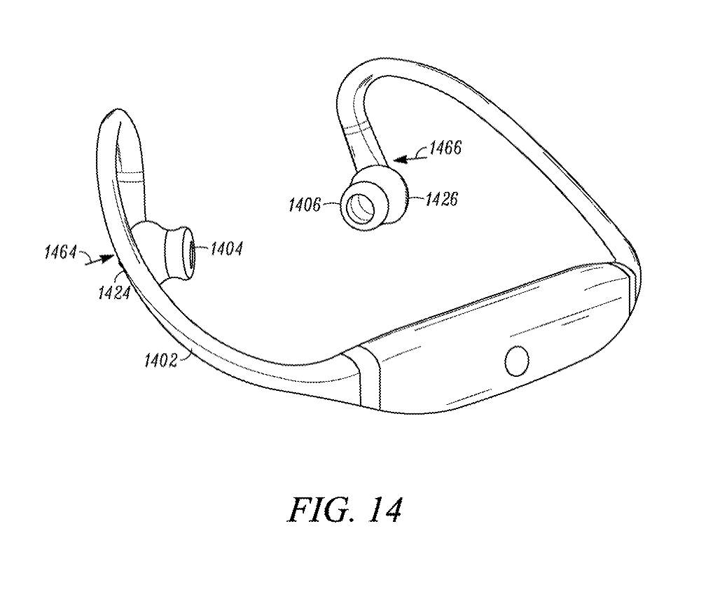

FIGS. 13 and 14 depict a headset 1302 and 1402 and include arrows 1354, 1356, 1464 and 1466 proximal earbuds on different sides of the headset 1304, 1306, 1404 and 1406, respectively. In FIG. 13, the arrows 1354 and 1356 indicate the gestural movements along the elongate strip touch-sensitive surface vertically positioned on each side the headset, which in this example is an around the back of the head headset. The double-headed arrow 1354 indicates that the track forward and track back motion may be in the vertical direction. The double-headed arrow 1356 indicates that the volume adjustment for volume up and volume down may be in the vertical direction.

FIG. 14 depicts a headset and includes an arrow indicating a pressure point 1464 for calling controls. As mentioned above, pressing at a specific or at any point 1464 on the touch-sensitive surface can generate user input signals for communication answer control output signals and communication end control output signals, for example, alternately. Also, pressing at a specific or at any point 1466 on the touch-sensitive surface of the user interface to generate user input signals for play control output signals and pause control output signals, for example, alternately.

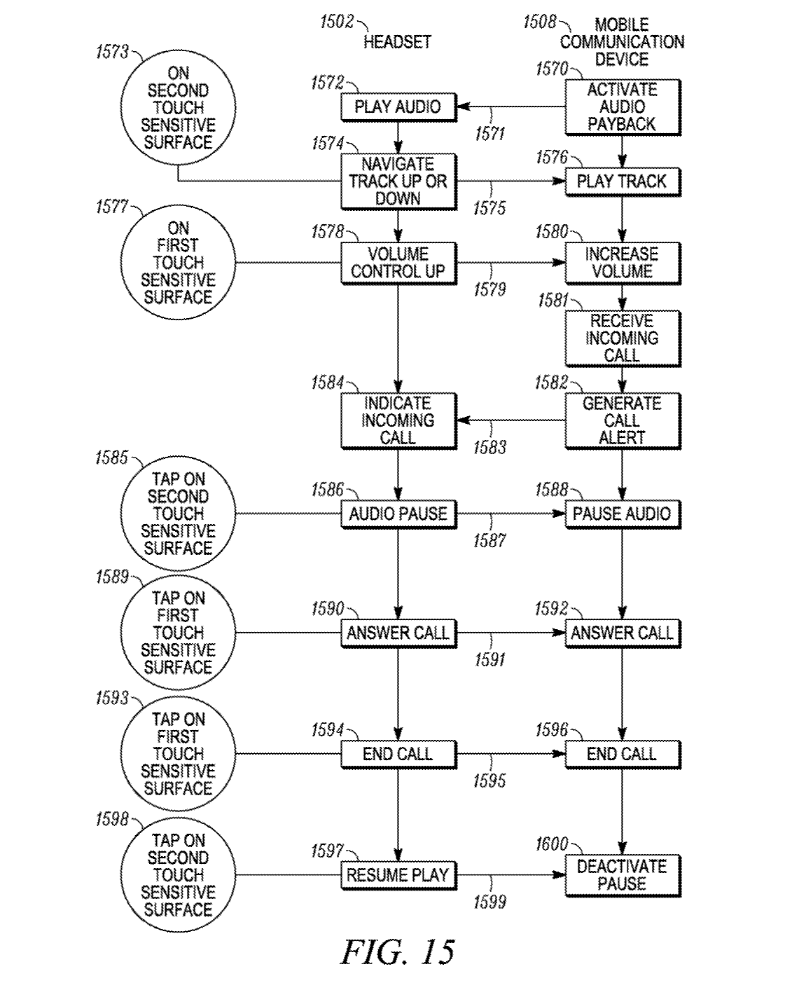

FIG. 15 is a flowchart indicating a scenario including a series of input user signals that a user may provide to a touch-sensitive surface to generate output signals while the headset 102 (see FIG. 1) is in communication with a mobile communication device 108. The headset 1502 and the mobile communication device 1508 may be in wired or wireless communication, and in particular, Bluetooth communication. A user may activate a function on the mobile communication device 1508 such as the audio playback 1570 and transmit a signal 1571 to the headset 1502 that can play the audio 1572 by conveying the sound to the user via the earbuds 104 and 106 (see FIG. 1). By directional motion on the second touch sensitive surface 1573, the user may chose to navigate the tracks 1574 and send a signal 1575 to play a particular track 1576. By directional motion on the first touch sensitive surface 1577, the user may then choose to adjust the volume 1578 of the audio playback. A signal to adjust the volume 1579 can be sent to the mobile communication device 1508 which can adjust 1580 the signal to the headset 1502.

In this scenario, during the audio playback, the mobile communication device 1508 can receive an incoming communication signal 1581 and generate a call alert 1582 and send a signal 1583 to the headset 1502 to indicate an incoming call 1584. If the user chooses to accept the call, the user can press or tap on the second touch-sensitive surface 1585 to indicate an audio pause 1586, a signal 1587 for which can be sent to the mobile communication device 1508 to pause the audio 1588.

By a press or a tap on the first touch-sensitive surface 1589, the user can answer the call 1590. An answer signal 1591 is sent to the mobile communication device 1508 so that it establishes communication with the incoming call 1592. By a press or tap on the first touch-sensitive surface 1593, the user can end the call 1594 so that a signal 1595 is sent to the mobile communication device to end the call 1596. The user may wish to resume play of the audio playback 1597 and so may press or tap on the second touch-sensitive surface 1598 so that a signal 1599 is sent to the mobile communication device 1508 to deactivate pause and resume play 1600.

Accordingly, the described user interface of a headset can provide multiple functions in a small space but with minimal buttons. The disclosed user interface on two sides of the headset can include two touch-sensitive surfaces that are configured to detect certain gestural motions. In addition to the conventional “press” functionality of the control, the touch-sensitive control may also accommodate a directional slide. Accordingly, the surface can detect sliding motions as well as pressure points. Therefore, the user can tap or press and slide in either direction along a touch-sensitive surface to allow three functions in the same space. Grouping of gestures and movements may provide memory cues for users to remember which side of the headset to use for certain functions.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A headset having a first side and a second side, the headset comprising:
a controller configured to receive user input signals and generate control output signals;
a first user interface located on the first side, the first user interface comprising a first touch-sensitive surface and coupled to the controller, the first user interface configured to detect linear movement along the surface in two directions and pressure on the first touch-sensitive surface; and
a second user interface located on the second side, the second user interface comprising a second touch-sensitive surface and coupled to the controller, the second interface configured to detect linear movement along the surface in two directions and detect pressure on the second touch-sensitive surface.

2. The headset of claim 1 wherein the first user interface that is configured to detect linear movement along the surface in two directions is further configured to generate user input signals for volume control output signals.

3. The headset of claim 1 wherein the first user interface that is configured to detect pressure on the first touch-sensitive surface is further configured to generate user input signals for communication answer control output signals and communication end control output signals.

4. The headset of claim 1 wherein the second user interface that is configured to detect linear movement along the surface in two directions is further configured to generate user input signals for track control output signals.

5. The headset of claim 1 wherein the second user interface that is configured to detect pressure on the second touch-sensitive surface is further configured to generate user input signals for play control output signals and pause control output signals.

6. The headset of claim 1, wherein the first touch-sensitive surface is resistive.

7. The headset of claim 1, wherein the first touch-sensitive surface is capacitive.

8. The headset of claim 1, wherein the headset includes a wired or wireless connection to a communication device in which a communication device function is activated in response to a user input signal at one of the touch-sensitive surfaces.

9. A headset having a first side and a second side, the headset comprising:
a controller configured to receive user input signals and generate control output signals;
a first user interface located on the first side, the first user interface comprising a first touch-sensitive surface and coupled to the controller, the first user interface configured to detect linear movement along the surface in two directions and to generate user input signals for volume control output signals, the first user interface further configured to detect pressure on the first touch-sensitive surface and to generate user input signals for communication answer control output signals and communication end control output signals; and
a second user interface located on the second side, the second user interface comprising a second touch-sensitive surface and coupled to the controller, the second user interface configured to detect linear movement along the surface in two directions and to generate user input signals for track control output signals, the second user interface further configured to detect pressure on the second touch-sensitive surface and to generate user input signals for play control output signals and pause control output signals.

10. The headset of claim 9, wherein the first touch-sensitive surface is resistive.

11. The headset of claim 9, wherein the first touch-sensitive surface is capacitive.

12. The headset of claim 9, wherein the headset includes a wired or wireless connection to a communication device in which a communication device function is activated in response to a user input signal at one of the touch-sensitive surfaces.

13. The headset of claim 9, wherein a detected linear movement along the first touch-sensitive surface in a first direction corresponds to decreasing volume control output signals.

14. The headset of claim 9, wherein a detected linear movement along the first touch-sensitive surface in a second direction corresponds to increasing volume control output signals.

15. The headset of claim 9, wherein a detected linear movement along the second touch-sensitive surface in a first direction corresponds to reverse track control output signals.

16. The headset of claim 9, wherein a detected linear movement along the second touch-sensitive surface in a second direction corresponds to advance track control output signals.

17. The headset of claim 9, wherein the first touch-sensitive surface is configured to detect pressure, and to generate user input signals for communication answer control output signals and communication end control output signals alternately.

18. The headset of claim 9, wherein the second touch-sensitive surface is configured to detect pressure, and to generate user input signals for play control output signals and pause control output signals alternately.

19. A user interface, comprising:
a controller configured to receive user input signals and generate control output signals;
a touch-sensitive surface coupled to the controller, the touch-sensitive surface configured to detect:
linear movement along the surface in a first direction and to generate user input signals;
a combination of linear movement along the surface in a direction and of pressure held for a predetermined period of time to generate user input signals;
linear movement along the surface in a second direction and to gene rate user input signals;
a combination of linear movement along the surface in a direction and of pressure held for a predetermined period of time and to generate user input signals;
pressure on the surface and to generate user input signals; and
pressure and pressure held for a predetermined period of time on the surface and to generate user input signals.
